(19) United States
(12) Patent Application Publication
(10) Pub. No.: US 2009/0004570 A1
(43) Pub. Date: Jan. 1, 2009

(54) Electrode for Non-Aqueous Electrolylte Secondary Battery, Method for Producing the Same, and Non-Aqueous Electrolyte Secondary Battery

(76) Inventor: Toshihiro Inoue, Osaka (JP)

Correspondence Address: MCDERMOTT WILL & EMERY LLP, 600 13TH STREET, NW, WASHINGTON, DC, 20005-3096, US

(21) Appl. No.: 12/281,424

(22) PCT Filed: Jun. 5, 2007
(86) PCT No.: PCT/JP2007/061324

§ 371 Date: Sep. 2, 2008

(30) Foreign Application Priority Data
Aug. 29, 2006 (JP) 2006-231486

(51) Int. Cl. H01M 2/16; H01M 4/02; H01M 10/04

(52) U.S. Cl. 429/246; 429/209; 29/623.5

(57) ABSTRACT

An electrode for a non-aqueous electrolyte secondary battery including a current collector and an electrode material mixture layer formed on the current collector, and having a plurality of discontinuous slits through the current collector and the electrode material mixture layer.

### TECHNICAL FIELD

The invention relates to an electrode for use in a non-aqueous electrolyte secondary battery such as a lithium secondary battery.

### BACKGROUND ART

A non-aqueous electrolyte secondary battery includes a positive electrode, a negative electrode, a separator interposed between the positive electrode and the negative electrode, and a non-aqueous electrolyte. The non-aqueous electrolyte performs the function of allowing ions to move between the positive electrode and the negative electrode. Each of the positive electrode and the negative electrode includes a current collector made of, for example, metal foil and an electrode material mixture layer formed on the current collector. The electrode material mixture layer contains an active material as an essential component and contains a conductive agent, a binder, etc., as optional components.

The positive electrode of the non-aqueous electrolyte secondary battery includes, for example, a lithium-containing composite oxide such as lithium cobaltate as the active material. The positive electrode current collector commonly comprises aluminum foil. Meanwhile, the negative electrode includes a carbon material such as graphite or non-graphitizable carbon as the active material. The negative electrode current collector commonly comprises copper foil. The non-aqueous electrolyte is usually composed of a non-aqueous solvent and a solute dissolved therein. The solute is, for example, a lithium salt.

In terms of heightening the capacity of the non-aqueous electrolyte secondary battery, it is desired to increase the concentration of the solute contained in the non-aqueous electrolyte in order to promote charge/discharge reaction. Also, in terms of enhancing the productivity of the battery, it is desired to inject a given amount of the non-aqueous electrolyte into the limited space inside the case within a short period of time. However, when the non-aqueous electrolyte has a high solute concentration, its viscosity is high, and thus, the permeation of the non-aqueous electrolyte into the electrode group takes a long time, thereby resulting in a low productivity.

In order for the non-aqueous electrolyte to permeate the electrode group, the gas in the electrode group needs to be readily replaced with the non-aqueous electrolyte. For example, the gas accumulated in the electrodes or near the electrodes should be promptly discharged from the electrode group. To achieve this, it is effective to provide the current collector with holes through which the gas passes.

As current collectors having holes, it has been proposed to use, for example, expanded metal and lath metal having a mesh structure. However, these proposals intend to integrate the electrode material mixture layers on both faces of a current collector by using the holes in order to prevent the separation of the active material from the current collector (see Patent Documents 1, 2 and 3).

It has also been proposed to provide a current collector with a plurality of discontinuous slits (see Patent Document 4). However, this proposal intends to heighten the density of the electrode material mixture layer carried on the current collector.

It has also been proposed to provide a current collector with through-holes with a major axis of 5 to 1000 μm and a minor axis of 2 to 100 μm, wherein the ratio of the major axis to the minor axis satisfies 20≦major axis/minor axis≦100. According to this proposal, when the electrode material mixture is rolled in the direction perpendicular to the direction of the major axis, the active material is unlikely to enter the through-holes, so that the gas passage is promoted by the through-holes (see Patent Document 5).

It has also been proposed to form slits in an electrode material mixture layer in order to promote the permeation of non-aqueous electrolyte into the electrode material mixture layer (see Patent Document 6).

Patent Document 1: Japanese Laid-Open Patent Publication No. Hei 10-321240

Patent Document 2: Japanese Laid-Open Patent Publication No. 2001-297753

Patent Document 3: Japanese Laid-Open Patent Publication No. 2005-38612

Patent Document 4: Japanese Laid-Open Patent Publication No. Hei 7-169461

Patent Document 5: Japanese Laid-Open Patent Publication No. Hei 11-97035

Patent Document 6: Japanese Laid-Open Patent Publication No. 2005-108640

### DISCLOSURE OF THE INVENTION

### Problem to be Solved by the Invention

The current collectors proposed by Patent Documents 1 to 3 have a mesh structure, so the adhesion of the electrode material mixture layer to the current collector tends to be insufficient. The use of a mesh current collector is more likely to cause separation of the active material from the current collector than the use of a foil current collector. Also, when the holes in the current collector are enlarged, the active material is filled into the holes, which impairs the gas passage through the electrode.

Patent Documents 4 and 5 propose forming slits only in the current collector. The slits formed in the current collector are thus covered with the electrode material mixture layer. Hence, the gas cannot easily pass through the electrode.

Patent Document 6 proposes forming slits only in the electrode material mixture layer. According to this proposal, even when the density of the electrode group is heightened, the non-aqueous electrolyte can easily permeate the electrode material mixture layer. It is thus possible to increase the amount of the active material contained in the limited space inside the case. However, the formation of the slits only in the electrode material mixture layer does not enable the gas to easily pass through the electrode.

In view of the problems as described above, an object of the invention is to promptly discharge the gas accumulated in the electrode or near the electrode from the electrode group, improve the permeation of the non-aqueous electrolyte, and enhance the productivity of the non-aqueous electrolyte secondary battery.

### Means for Solving the Problem

The invention relates to an electrode for a non-aqueous electrolyte secondary battery, including a current collector and an electrode material mixture layer formed on the current collector, and having a plurality of discontinuous slits through the current collector and the electrode material mixture layer.

When the current collector is rectangular, the plurality of discontinuous slits are desirably inclined relative to at least one side of the current collector.

When the current collector is in the form of a strip, the plurality of discontinuous slits are desirably inclined relative to the longitudinal direction of the current collector.

The angle formed between the plurality of discontinuous slits and the at least one side of the current collector is preferably 10° or more and 80° or less.

In one mode of the invention, the plurality of discontinuous slits have a length of 10 μm or more and 10000 μm or less and a width of 0.5 μm or more and 200 μm or less.

The invention pertains to a non-aqueous electrolyte secondary battery including an electrode group, a non-aqueous electrolyte, and a case for encapsulating the electrode group and the non-aqueous electrolyte therein. The electrode group includes a positive electrode, a negative electrode, and a separator interposed between the positive electrode and the negative electrode, and at least one of the positive electrode and the negative electrode is the electrode as described in the above.

In one mode of the invention, the positive electrode includes a positive electrode current collector and a positive electrode material mixture layer formed on the positive electrode current collector, and has a plurality of discontinuous slits through the positive electrode current collector and the positive electrode material mixture layer. Also, the negative electrode includes a negative electrode current collector and a negative electrode material mixture layer formed on the negative electrode current collector, and has a plurality of discontinuous slits through the negative electrode current collector and the negative electrode material mixture layer. The plurality of discontinuous slits of the positive electrode intersect with the plurality of discontinuous slits of the negative electrode.

The invention is directed to a method for producing an electrode for a non-aqueous electrolyte secondary battery. The method includes the steps of: applying a paste containing an electrode material mixture onto a current collector; drying the paste applied onto the current collector to form an unrolled electrode material mixture layer; forming a plurality of discontinuous slits through the current collector and the unrolled electrode material mixture layer; and rolling the unrolled electrode material mixture layer.

The current collector according to the invention is not a current collector having a large number of openings like conventional lath metal foil. Also, the proposals that have been made so far relate to techniques of forming slits only in a current collector or only in an electrode material mixture layer. Therefore, the electrode of the invention is different from conventional electrodes in that it has a plurality of discontinuous slits through the current collector and the electrode material mixture layer.

### EFFECT OF THE INVENTION

According to the invention, the permeation of the non-aqueous electrolyte into the electrode group is improved, and the productivity of the non-aqueous electrolyte secondary battery is dramatically improved. Also, according to the production method of the invention, it is possible to easily obtain an electrode having a plurality of discontinuous slits through the current collector and the electrode material mixture layer.

### BRIEF DESCRIPTION OF THE DRAWING

FIG. 1 is a partially cut-away perspective view of a non-aqueous electrolyte secondary battery according to one embodiment of the invention.

### BEST MODE FOR CARRYING OUT THE INVENTION

An electrode of the invention includes a current collector and an electrode material mixture layer formed on the current collector, and has a plurality of discontinuous slits through the current collector and the electrode material mixture layer. Since the discontinuous slits penetrate through both the current collector and the electrode material mixture layer, the passage of gas through the electrode becomes easy, so that the permeation of the non-aqueous electrolyte into the electrode group is dramatically improved.

At least a part of the discontinuous slits should penetrate through the current collector and the electrode material mixture layer; it is desirable that most of them or all of them penetrate through the current collector and the electrode material mixture layer. For example, it is preferable that not less than 50% of the slits penetrate through the current collector and the electrode material mixture layer.

When the electrode material mixture layer is carried on each side of the current collector, the discontinuous slits may penetrate through only the current collector and the electrode material mixture layer carried on one side thereof, or may penetrate through the current collector and the electrode material mixture layers carried on both sides thereof.

In terms of effectively replacing the gas inside the electrode group with the non-aqueous electrolyte to cause the non-aqueous electrolyte to permeate the electrode group, the number of the slits per unit area is preferably about 10 to per cm² or 20 to 100 per cm².

The material constituting the current collector is preferably metal foil. The metal constituting the metal foil is not particularly limited. The preferable positive electrode current collector for a lithium secondary battery is, for example, aluminum foil, aluminum alloy foil, etc., and the preferable negative electrode current collector is, for example, copper foil, copper alloy foil, etc. The copper foil can be rolled-copper foil (copper foil obtained by rolling) or can be electrolytic copper foil (copper foil obtained by electrolysis).

The thickness of the current collector is preferably 3 to 25 μm, or 4 to 12 μm. If the thickness of the current collector is less than 3 μm, the mechanical strength of the current collector itself is so low that the current collector may break during the production of a battery (e.g., when the current collector is wound) . If the thickness of the current collector exceeds 20 μm, the battery becomes heavy or the volume of the current collector becomes large, which is disadvantageous for reducing the weight and size of the battery.

Specifically, in the case of a current collector made of copper foil or copper alloy foil for use in the negative electrode for a lithium secondary battery, the preferable thickness is approximately 8 to 12 μm. In the case of a current collector made of aluminum foil or aluminum alloy foil for use in the positive electrode of a lithium secondary battery, the preferable thickness is approximately 10 to 25 μm. When the lithium secondary battery is a polymer battery, it is preferable to use metal foil thinner than a common lithium ion battery.

The electrode material mixture layer contains an active material as an essential component and contains a conductive agent, a binder, etc., as optional components. The positive electrode active material of the lithium secondary battery includes, for example, a lithium-containing composite oxide. The kind of the lithium-containing composite oxide is not particularly limited, and for example, lithium cobaltate, lithium nickelate, or lithium manganate can be used. The negative electrode active material of the lithium secondary battery includes, for example, graphite, non-graphitizable carbon, etc.

The thickness of the electrode material mixture is preferably 50 to 150 μm or 70 to 90 μm. If the electrode material mixture is too thin, the electrode capacity may become insufficient. If the electrode material mixture is too thick, the current-collecting capability may decrease.

Specifically, in the case of a negative electrode material mixture layer for a lithium secondary battery, when a graphite-type negative electrode active material is used, the preferable thickness is approximately 50 to 100 μm. Examples of graphite-type negative electrode active materials include natural graphite (flake graphite and the like) and artificial graphite (lump graphite and the like).

While the shape of the current collector is not particularly limited, it is commonly in the form of a rectangular sheet, for example, in the form of a strip. When the shape of the current collector is rectangular, the discontinuous slits are desirably inclined relative to at least one side of the current collector. Particularly when the current collector is in the form of a strip, the discontinuous slits are desirably inclined relative to the longitudinal direction of the current collector. In the case of the slits being inclined relative to at least one side of the current collector or the longitudinal direction of the current collector, when the positive electrode, the separator, and the negative electrode are laminated, the slits of the positive electrode are able to intersect with the slits of the negative electrode. Hence, the gas can easily pass through the electrodes, and the permeation of the non-aqueous electrolyte into the electrode group is dramatically improved, thereby resulting in an enhanced productivity.

It is good that at least a part of the discontinuous slits be inclined relative to at least one side of the current collector; it is desirable that most of them or all of them be inclined relative to at least one side of the current collector. Also, all of the discontinuous slits do not need to incline in the same direction, but all of the slits may incline in the same direction.

The angle formed between the discontinuous slits and at least one side of the current collector is preferably 10° or more and 80° or less, or 30° to 60°. Likewise, the angle formed between the discontinuous slits and the longitudinal direction of the strip-like current collector is preferably 10° or more and 80° or less, or 30° to 60°.

For example, if the angle formed between the slits and the longitudinal direction of the strip-like current collector is close to 90°, the mechanical strength of the current collector may decrease when a tension in the longitudinal direction is applied. For example, when the electrode is wound, the current collector may stretch. Also, if the angle formed between the slits and the longitudinal direction of the strip-like current collector is close to 0°, the slits are almost parallel to the longitudinal direction. Thus, when the non-aqueous electrolyte is injected from above the electrode group comprising the wound electrodes, slits almost parallel to the longitudinal direction are orthogonal to the vertical direction of the electrode group, which is the gas moving direction. Hence, the slits may be less effective in discharging the gas from the electrode group.

While the lengths of all the discontinuous slits do not have to be the same, they are preferably 10 μm or more and 10000 μm or less. If the lengths of the slits are less than 10 μm, the total area where the slits are formed is small. In this case, the replacement of the gas inside the electrode group by the non-aqueous electrolyte may become insufficient unless the number of the slits per unit area is increased. If the lengths of the slits are more than 10000 μm, the strength of the current collector may become low.

While the widths of all the discontinuous slits do not have to be the same, they are preferably 0.5 μm or more and 200 μm or less. If the widths of the slits are less than 0.5 μm, the total area where the slits are formed is small. In this case, the replacement of the gas inside the electrode group by the non-aqueous electrolyte may become insufficient unless the number of the slits per unit area is increased. If the widths of the slits are more than 200 μm, the active material may enter the slits, so that the passage of the gas through the electrode may become insufficient.

The ratio of the length L of the slits to the width W (aspect ratio: L/W) is preferably 10 to 10000, or 50 to 2000. If the aspect ratio is too low, the shape of the slits becomes close to a circle. Hence, when the aspect ratio is low, the replacement of the gas inside the electrode group by the non-aqueous electrolyte may become insufficient unless the number of the slits per unit area is increased.

On the other hand, if the aspect ratio is too high, the slits are likely to open in the thickness direction of the current collector when an external force is applied to the current collector. If the slits open, the active material may enter the slits, so that the passage of the gas through the electrode may become insufficient.

In one mode of the invention, the electrode group is fabricated, for example, by winding a positive electrode strip and a negative electrode strip with a separator interposed therebetween. In another mode of the invention, the electrode group is fabricated, for example, by laminating a positive electrode and a negative electrode with a separator interposed therebetween.

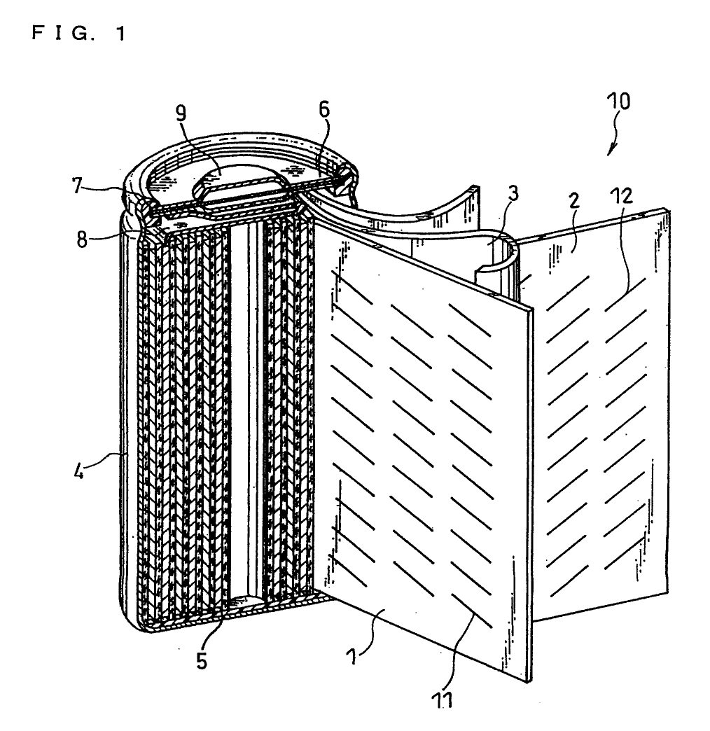

One embodiment of the non-aqueous electrolyte battery is described with reference to FIG. 1.

A non-aqueous electrolyte secondary battery usually includes an electrode group 10, a non-aqueous electrolyte, and a case 4 for encapsulating the electrode group 10 and the non-aqueous electrolyte therein. It is noted that in the non-aqueous electrolyte secondary battery of the invention, at least one of a positive electrode 2 and a negative electrode 1 is the above-described electrode, i.e., an electrode including a current collector, an electrode material mixture layer formed on the current collector, and a plurality of discontinuous slits through the current collector and the electrode material mixture layer. The positive electrode 2 and the negative electrode 1 are wound with a separator 3 interposed therebetween, and contained in a cylindrical case 4. A part of the negative electrode 1 is in contact with the inner side face of the case 4. The circumference of a seal plate 6, which seals the opening of the case 4, is crimped with the open edge of the case 4 with a gasket 7 interposed therebetween. The seal plate 6 is equipped with an external terminal 9. A positive electrode lead 8 is connected to a predetermined position of the seal plate 6.

In FIG. 1, the positive electrode 2 includes a positive electrode current collector, a positive electrode material mixture layer formed on the positive electrode current collector, and a plurality of discontinuous slits 12 through the positive electrode current collector and the positive electrode material mixture layer, while the negative electrode 1 includes a negative electrode current collector, a negative electrode material mixture layer formed on the negative electrode current collector, and a plurality of discontinuous slits 11 through the negative electrode current collector and the negative electrode material mixture layer. The discontinuous slits 12 of the positive electrode 2 intersect with the discontinuous slits 11 of the negative electrode 1.

The discontinuous slits 12 of the positive electrode 2 intersect with the discontinuous slits 11 of the negative electrode 1, thereby forming points at which the positive electrode 2, the separator 3, and the negative electrode 1 are penetrated through. Thus, the permeation of the non-aqueous electrolyte in the thickness direction of the electrodes is improved. Also, the passage of the gas through the electrodes becomes easy, and the permeation of the non-aqueous electrolyte into the electrode group 10 is dramatically improved, thereby resulting in an increased productivity.

To produce an electrode for a non-aqueous electrolyte secondary battery according to the invention, first, a paste containing an electrode material mixture is applied onto a current collector (both faces or one face). Common metal foil having no slits or holes is used as the current collector.

The paste containing an electrode material mixture is prepared by mixing an electrode material mixture with a liquid component. The liquid component is not particularly limited, and for example, water, alcohol, N-methyl-2-pyrrolidone, and cyclohexanone can be used.

Next, the paste applied onto the current collector is dried to form an unrolled electrode material mixture layer. The drying temperature and drying time differ according to the composition of the electrode material mixture and the liquid component of the paste.

Usually, this drying step is followed by a step of rolling the unrolled electrode material mixture layer and the current collector. However, to produce an electrode of the invention, it is desirable to perform a step of forming a plurality of discontinuous slits through the current collector and the unrolled electrode material mixture layer before the rolling. If the slits through the current collector and the electrode material mixture layer are formed after the rolling, the electrode material mixture layer may separate from the current collector or the electrode material mixture may drop from the slit portions.

The discontinuous slits through the current collector and the unrolled electrode material mixture layer can be formed by a given method. Examples of such methods include embossing, punching, and pressing, and pressing is preferable.

After the formation of the discontinuous slits through the current collector and the unrolled electrode material mixture layer, the unrolled electrode material mixture layer is rolled. The rolling method is not particularly limited.

When the electrode material mixture paste is applied onto the current collector having no slits or holes as described above, variations in the amount of the paste applied are suppressed since there are almost no burrs or roughness on the surface of the current collector.

Next, the invention is specifically described based on Examples, but the invention is not limited to the following Examples.

### EXAMPLE 1

### (i) Preparation of Positive Electrode

A rolled aluminum foil with a thickness of 15 μm, a width of 500 mm, and a length of 500 m was used as a positive electrode current collector stuff.

A mixture of a positive electrode active material comprising lithium cobaltate (LiCoO₂), a conductive agent comprising artificial graphite (KS-4 available from TIMCAL), and a binder comprising polyvinylidene fluoride was used as a positive electrode material mixture. The composition of the positive electrode material mixture was set so that (lithium cobaltate):(artificial graphite):(polyvinylidene fluoride)=87:9:4 (weight ratio).

A positive electrode material mixture paste was prepared by kneading N-methyl-2-pyrrolidone with polyvinylidene fluoride dissolved therein, lithium cobaltate, and the conductive agent.

The positive electrode material mixture paste was applied onto both faces of the aluminum foil, followed by drying. The thickness of the dried unrolled electrode material mixture layer per one face was set to 94 μm.

Next, a plurality of discontinuous slits were formed through the current collector and the unrolled electrode material mixture layers by continuous press working. The respective slits had a length of 2000 μm and a width of 10 μm. The directions of all the slits and the angles (inclination) formed between all the slits and one side of the positive electrode current collector were the same. The angle formed between the slits and one side of the positive electrode current collector was set to 30°. The interval between the slits was set to 4 mm.

That is, in each of the length direction and the width direction of the slits, the slits were provided at intervals of 4 mm. It should be noted that the interval between the slits should be determined in consideration of the strength of the electrode plate, etc., and is not particularly limited.

After the formation of the slits, the unrolled electrode material mixture layers were rolled so that the total thickness of the positive electrode material mixture layers on both sides was 174 μm. Thereafter, the resultant electrode plate was cut to obtain a positive electrode strip in which the angle θₚ formed between the slits and the longitudinal direction of the positive electrode was 30°.

### (ii) Preparation of Negative Electrode

An electrolytic copper foil with a thickness of 10 μm, a width of 500 mm, and a length of 500 m was used as a negative electrode current collector.

A mixture of an active material comprising artificial graphite (MAG graphite available from Hitachi Chemical Co., Ltd.) and a binder comprising polyvinylidene fluoride was used as a negative electrode material mixture. The composition of the negative electrode material mixture was set so that (artificial graphite):(polyvinylidene fluoride)=90:10 (weight ratio).

A negative electrode material mixture paste was prepared by kneading N-methyl-2-pyrrolidone with polyvinylidene fluoride dissolved therein and artificial graphite.

The negative electrode material mixture paste was applied onto both faces of the copper foil, followed by drying. The thickness of the dried unrolled electrode material mixture layer per one face was set to 84 μm.

Next, a plurality of discontinuous slits were formed through the current collector and the unrolled electrode material mixture layers by continuous press working. The respective slits had a length of 2000 μm and a width of 10 μm. The directions of all the slits and the angles (inclination) formed between all the slits and one side of the negative electrode current collector were the same. The angle formed between the slits and one side of the negative electrode current collector was set to 30°. The interval between the slits was set to 4 mm.

That is, in each of the length direction and the width direction of the slits, the slits were provided at intervals of 4 mm.

After the formation of the slits, the unrolled electrode material mixture layers were rolled so that the total thickness of the negative electrode material mixture layers on both sides was 156 μm. Thereafter, the resultant electrode plate was cut to obtain a negative electrode strip in which the angle θₙ formed between the slits and the longitudinal direction of the negative electrode was 30°.

### (iii) Fabrication of Electrode Group and Electrolyte Injection Test

The positive electrode and the negative electrode were wound with a separator interposed therebetween to obtain an electrode group.

At this time, the positive electrode and the negative electrode faced each other in such a manner that the discontinuous slits of the positive electrode intersected with the discontinuous slits of the negative electrode. Thereafter, the electrode group was placed into a case (cylindrical battery can with a bottom), and a non-aqueous electrolyte injection test was conducted. In the electrolyte injection test, 5 g of a non-aqueous electrolyte was injected into the case containing the electrode group, the pressure inside the case was reduced to 5×10⁵ Pa, and the time required for the non-aqueous electrolyte to completely permeate the electrode group (injection time) was obtained. Table 1 shows the results of injection times.

Herein, a 20-μm thick separator (Hipore SV718) available from Asahi Kasei Chemicals was used. A non-aqueous electrolyte prepared by dissolving lithium hexafluorophosphate (LiPF₆) at a concentration of 1.5 mol/L in a solvent mixture of ethylene carbonate and dimethyl carbonate in a volume ratio of 1:2 was used.

After the electrolyte injection test, the opening of the case was sealed with a seal plate, to obtain a lithium ion battery with a rated capacity of 2400 mAh. The battery size was the 18650 size, with a diameter of 18 mm and a height of 65 mm.

### EXAMPLE 2

An electrode group was produced in the same manner as in Example 1 (i.e., the slits of the positive electrode and the negative electrode were allowed to intersect with one another), except that the angle θₚ formed between the slits of the positive electrode and the longitudinal direction of the positive electrode was set to 45°, and that the angle θₙ formed between the slits of the negative electrode and the longitudinal direction of the negative electrode was set to 45°. The electrode group was subjected to an electrolyte injection test to complete a battery.

### EXAMPLE 3

An electrode group was produced in the same manner as in Example 1 except that the angle θₚ formed between the slits of the positive electrode and the longitudinal direction of the positive electrode was set to 60°, and that the angle θₙ formed between the slits of the negative electrode and the longitudinal direction of the negative electrode was set to 60°. The electrode group was subjected to an electrolyte injection test to complete a battery.

### EXAMPLE 4

An electrode group was produced in the same manner as in Example 1 except that the angle θₚ formed between the slits of the positive electrode and the longitudinal direction of the positive electrode was set to 30°, and that the angle θₙ formed between the slits of the negative electrode and the longitudinal direction of the negative electrode was set to 60°. The electrode group was subjected to an electrolyte injection test to complete a battery.

### EXAMPLE 5

An electrode group was produced in the same manner as in Example 1 except that the angle θₚ formed between the slits of the positive electrode and the longitudinal direction of the positive electrode was set to 10°, and that the angle θₙ formed between the slits of the negative electrode and the longitudinal direction of the negative electrode was set to 10°. The electrode group was subjected to an electrolyte injection test to complete a battery.

### EXAMPLE 6

An electrode group was produced in the same manner as in Example 1 except that the angle θₚ formed between the slits of the positive electrode and the longitudinal direction of the positive electrode was set to 80°, and that the angle θₙ formed between the slits of the negative electrode and the longitudinal direction of the negative electrode was set to 80°. The electrode group was subjected to an electrolyte injection test to complete a battery.

### EXAMPLE 7

An electrode group was produced in the same manner as in Example 1 except that no slits were formed in the negative electrode. The electrode group was subjected to an electrolyte injection test to complete a battery.

### EXAMPLE 8

An electrode group was produced in the same manner as in Example 1 except that no slits were formed in the positive electrode. The electrode group was subjected to an electrolyte injection test to complete a battery.

### EXAMPLE 9

An electrode group was produced in the same manner as in Example 1, except that the length of the slits of the positive electrode was changed to 10000 μm and the width thereof to 200 μm and that the length of the slits of the negative electrode was changed to 10000 μm and the width thereof to 200 μm. The electrode group was subjected to an electrolyte injection test to complete a battery.

### EXAMPLE 10

An electrode group was produced in the same manner as in Example 1, except that the length of the slits of the positive electrode was changed to 10000 μm and the width thereof to 0.5 μm and that the length of the slits of the negative electrode was changed to 10000 μm and the width thereof to 0.5 μm. The electrode group was subjected to an electrolyte injection test to complete a battery.

### EXAMPLE 11

An electrode group was produced in the same manner as in Example 1, except that the length of the slits of the positive electrode was changed to 10 μm and the width thereof to 0.5 μm and that the length of the slits of the negative electrode was changed to 10 μm and the width thereof to 0.5 μm. The electrode group was subjected to an electrolyte injection test to complete a battery.

### EXAMPLE 12

An electrode group was produced in the same manner as in Example 1 except that the angle θₚ formed between the slits of the positive electrode and the longitudinal direction of the positive electrode was set to 5°, and that the angle θₙ formed between the slits of the negative electrode and the longitudinal direction of the negative electrode was set to 85°. The electrode group was subjected to an electrolyte injection test to complete a battery.

### EXAMPLE 13

An electrode group was produced in the same manner as in Example 1 except that the angle θₚ formed between the slits of the positive electrode and the longitudinal direction of the positive electrode was set to 85°, and that the angle θₙ formed between the slits of the negative electrode and the longitudinal direction of the negative electrode was set to 85°. The electrode group was subjected to an electrolyte injection test to complete a battery.

### EXAMPLE 14

An electrode group was produced in the same manner as in Example 1 except that the angle θₚ formed between the slits of the positive electrode and the longitudinal direction of the positive electrode was set to 5°, and that the angle θₙ formed between the slits of the negative electrode and the longitudinal direction of the negative electrode was set to 5°. The electrode group was subjected to an electrolyte injection test to complete a battery.

### EXAMPLE 15

An electrode group was produced in the same manner as in Example 1 except that the angle θₚ formed between the slits of the positive electrode and the longitudinal direction of the positive electrode was set to 0°, and that the angle θₙ formed between the slits of the negative electrode and the longitudinal direction of the negative electrode was set to 0°. The electrode group was subjected to an electrolyte injection test to complete a battery.

### EXAMPLE 16

An electrode group was produced in the same manner as in Example 1, except that the length of the slits of the positive electrode was changed to 5 μm and the width thereof to 0.5 μm and that the length of the slits of the negative electrode was changed to 5 μm and the width thereof to 0.5 μm. The electrode group was subjected to an electrolyte injection test to complete a battery.

### EXAMPLE 17

An electrode group was produced in the same manner as in Example 1, except that the length of the slits of the positive electrode was changed to 50000 μm and the width thereof to 0.5 μm and that the length of the slits of the negative electrode was changed to 50000 μm and the width thereof to 0.5 μm. The electrode group was subjected to an electrolyte injection test to complete a battery.

### EXAMPLE 18

An electrode group was produced in the same manner as in Example 1, except that the length of the slits of the positive electrode was changed to 2000 μm and the width thereof to 0.3 μm and that the length of the slits of the negative electrode was changed to 2000 μm and the width thereof to 0.3 μm. The electrode group was subjected to an electrolyte injection test to complete a battery.

### EXAMPLE 19

An electrode group was produced in the same manner as in Example 1, except that the length of the slits of the positive electrode was changed to 2000 μm and the width thereof to 250 μm and that the length of the slits of the negative electrode was changed to 2000 μm and the width thereof to 250 μm. The electrode group was subjected to an electrolyte injection test to complete a battery.

### COMPARATIVE EXAMPLE 1

A positive electrode was prepared by forming slits in the positive electrode current collector before applying the positive electrode material mixture paste thereto, thereafter applying the positive electrode material mixture paste onto the positive electrode current collector with the slits, drying it, and rolling it. Likewise, a negative electrode was prepared by forming slits in the negative electrode current collector before applying the negative electrode material mixture paste thereto, thereafter applying the negative electrode material mixture paste onto the negative electrode current collector with the slits, drying it, and rolling it. Except for the above, in the same manner as in Example 1, an electrode group was produced, and an electrolyte injection test was conducted to complete a battery.

### COMPARATIVE EXAMPLE 2

An electrode group was produced in the same manner as in Example 1, except that in the preparation of a positive electrode and a negative electrode, the press pressure for continuous press working was lowered so that slits were not formed in the current collector and slits were formed only in the electrode material mixture layers. The electrode group was subjected to an electrolyte injection test to complete a battery. It is noted that the slits were formed in the electrode material mixture layers on both faces of the positive electrode and the negative electrode.

### COMPARATIVE EXAMPLE 3

An electrode group was produced in the same manner as in Example 1, except that no slits were formed in the positive electrode and the negative electrode. The electrode group was subjected to an electrolyte injection test to complete a battery.

Table 1 shows the injection times in the respective Examples and Comparative Examples.

TABLE 1

| | Slits in | | | | | | | | |
|---|---|---|---|---|---|---|---|---|---|
| | electrode | | | | | | | | |
| | material | Slits in | Positive electrode slits | | | Negative electrode slits | | | Injection |
| | mixture | current | Length | Width | Angle | Length | Width | Angle | time |
| | layer | collector | (μm) | (μm) | θ p | (μm) | (μm) | θ n | (min) |
| Example 1 | Present | Present | 2000 | 10 | 30° | 2000 | 10 | 30° | 45 |
| Example 2 | Present | Present | 2000 | 10 | 45° | 2000 | 10 | 45° | 45 |
| Example 3 | Present | Present | 2000 | 10 | 60° | 2000 | 10 | 60° | 44 |
| Example 4 | Present | Present | 2000 | 10 | 30° | 2000 | 10 | 60° | 45 |
| Example 5 | Present | Present | 2000 | 10 | 10° | 2000 | 10 | 10° | 48 |
| Example 6 | Present | Present | 2000 | 10 | 80° | 2000 | 10 | 80° | 48 |
| Example 7 | Present | Present | 2000 | 10 | 30° | — | — | — | 54 |
| Example 8 | Present | Present | — | — | — | 2000 | 10 | 30° | 56 |
| Example 9 | Present | Present | 10000 | 200 | 30° | 10000 | 200 | 30° | 43 |
| Example 10 | Present | Present | 10000 | 0.5 | 30° | 10000 | 0.5 | 30° | 51 |
| Example 11 | Present | Present | 10 | 0.5 | 30° | 10 | 0.5 | 30° | 55 |
| Example 12 | Present | Present | 2000 | 10 | 5° | 2000 | 10 | 85° | 57 |
| Example 13 | Present | Present | 2000 | 10 | 85° | 2000 | 10 | 85° | 57 |
| Example 14 | Present | Present | 2000 | 10 | 5° | 2000 | 10 | 5° | 58 |
| Example 15 | Present | Present | 2000 | 10 | 0° | 2000 | 10 | 0° | 60 |
| Example 16 | Present | Present | 5 | 0.5 | 30° | 5 | 0.5 | 30° | 61 |
| Example 17 | Present | Present | 50000 | 0.5 | 30° | 50000 | 0.5 | 30° | 54 |
| Example 18 | Present | Present | 2000 | 0.3 | 30° | 2000 | 0.3 | 30° | 59 |
| Example 19 | Present | Present | 2000 | 250 | 30° | 2000 | 250 | 30° | 50 |
| Comp. | Absent | Present | 2000 | 10 | 30° | 2000 | 10 | 60° | 67 |
| Example 1 | | | | | | | | | |
| Comp. | Present | Absent | 2000 | 10 | 30° | 2000 | 10 | 60° | 66 |
| Example 2 | | | | | | | | | |
| Comp. | Absent | Absent | — | — | — | — | — | — | 68 |
| Example 3 | | | | | | | | | |

As shown in Table 1, in the respective Examples, the permeation of the non-aqueous electrolyte into the electrode group was significantly improved, so that the injection time could be shortened. A reduction in injection time significantly contributes to an improvement in productivity. It should be noted that these Examples did not exhibit a significant decrease in battery capacity due to repeated charge/discharge or a reduction in charge/discharge cycle life.

### INDUSTRIAL APPLICABILITY

The invention is applicable to non-aqueous electrolyte secondary batteries as a whole, but is particularly useful in non-aqueous electrolyte secondary batteries having high energy-density electrode groups. The shape of the non-aqueous electrolyte secondary battery of the invention is not particularly limited and can be any shape such as coin, button, sheet, cylindrical, flat, or prismatic shape. The form of the electrode group composed of a positive electrode, a negative electrode, and a separator can be of the wound-type or layered-type. The battery size may be small as in that used in compact portable appliances or may be large as in that for use in electric vehicles etc. The non-aqueous electrolyte secondary battery of the invention can be used as the power source, for example, for personal digital assistants, portable electronic appliances, small-sized power storage devices for home use, two-wheel motor vehicles, electric vehicles, and hybrid electric vehicles. The use thereof is not particularly limited.

1. An electrode for a non-aqueous electrolyte secondary battery, comprising a current collector and an electrode material mixture layer formed on said current collector, and having a plurality of discontinuous slits through said current collector and said electrode material mixture layer.

2. The electrode for a non-aqueous electrolyte secondary battery in accordance with claim 1, wherein said current collector is rectangular, and said plurality of discontinuous slits are inclined relative to at least one side of said current collector.

3. The electrode for a non-aqueous electrolyte secondary battery in accordance with claim 1, wherein said current collector is in the form of a strip, and said plurality of discontinuous slits are inclined relative to the longitudinal direction of said current collector.

4. The electrode for a non-aqueous electrolyte secondary battery in accordance with claim 1, wherein the angle formed between said plurality of discontinuous slits and said at least one side of said current collector is 10° or more and 80° or less.

5. The electrode for a non-aqueous electrolyte secondary battery in accordance with claim 1, wherein said plurality of discontinuous slits have a length of 10 μm or more and 10000 μm or less and a width of 0.5 μm or more and 200 μm or less.

6. A non-aqueous electrolyte secondary battery comprising an electrode group, a non-aqueous electrolyte, and a case for encapsulating said electrode group and said non-aqueous electrolyte therein,
wherein said electrode group includes a positive electrode, a negative electrode, and a separator interposed between said positive electrode and said negative electrode, and at least one of said positive electrode and said negative electrode is the electrode of claim 1 for a non-aqueous electrolyte secondary battery.

7. A non-aqueous electrolyte secondary battery comprising an electrode group, a non-aqueous electrolyte, and a case for encapsulating said electrode group and said non-aqueous electrolyte therein,
wherein said electrode group includes a positive electrode, a negative electrode, and a separator interposed between said positive electrode and said negative electrode,
said positive electrode includes a positive electrode current collector and a positive electrode material mixture layer formed on said positive electrode current collector, and has a plurality of discontinuous slits through said positive electrode current collector and said positive electrode material mixture layer,
said negative electrode includes a negative electrode current collector and a negative electrode material mixture layer formed on said negative electrode current collector, and has a plurality of discontinuous slits through said negative electrode current collector and said negative electrode material mixture layer, and
said plurality of discontinuous slits of said positive electrode intersect with said plurality of discontinuous slits of said negative electrode.

8. A method for producing an electrode for a non-aqueous electrolyte secondary battery, comprising the steps of:
applying a paste containing an electrode material mixture onto a current collector;
drying said paste applied onto said current collector to form an unrolled electrode material mixture layer;
forming a plurality of discontinuous slits through said current collector and said unrolled electrode material mixture layer; and
rolling said unrolled electrode material mixture layer.
